(19) United States
(12) Patent Application Publication
(10) Pub. No.: US 2024/0370766 A1
(43) Pub. Date: Nov. 7, 2024

(54) INPUT DATA MEMBERSHIP CLASSIFICATION

(71) Applicant: Microsoft Technology Licensing, LLC, Redmond, WA (US)

(72) Inventors: Laurent BOUÉ, Petah Tikva (IL); Kiran RAMA, Bangalore (IN)

(21) Appl. No.: 18/311,417

(22) Filed: May 3, 2023

(51) Int. Cl. G06N 20/00

(52) U.S. Cl. CPC G06N 20/00

(57) ABSTRACT

A computing system selects second data samples from second input data based on predictions from a surrogate membership classification model, wherein the second data samples are predicted by the surrogate membership classification model to be members of a second consistency class different from the first consistency class based on feature content of each data sample of the second input data. The computing system retrains the target machine learning model using the second data samples, based on the selecting operation.

### BACKGROUND

Performance degradation is a common topic of concern for machine learning technologies. One approach to counter such degradation is to update the training of machine learning models with more recent, more relevant training data. However, when machine learning models are trained over large amounts of data, it is impractical to retrain a model every time new data is encountered.

### SUMMARY

In some aspects, the techniques described herein relate to a method of retraining a target machine learning model trained by first data samples from first input data, the first data samples being classified as members of a first consistency class, the method including: selecting second data samples from second input data based on predictions from a surrogate membership classification model, wherein the second data samples are predicted by the surrogate membership classification model to be members of a second consistency class different from the first consistency class based on feature content of each data sample of the second input data; and retraining the target machine learning model using the second data samples, based on the selecting operation.

In some aspects, the techniques described herein relate to a computing system for retraining a target machine learning model trained by first data samples from first input data, the first data samples being classified as members of a first consistency class, the computing system including: one or more hardware processors; a retraining data selector executable by the one or more hardware processors and configured to select second data samples from second input data based on predictions from a surrogate membership classification model, wherein the retraining data selector includes a surrogate membership classification model configured to predict the second data samples from the second input data to be members of a second consistency class different from the first consistency class based on feature content of each data sample of the second input data; and a machine learning model retrainer executable by the one or more hardware processors and configured to retrain the target machine learning model using the second data samples.

In some aspects, the techniques described herein relate to one or more tangible processor-readable storage media embodied with instructions for executing on one or more processors and circuits of a computing device a process of retraining a target machine learning model trained by first data samples from first input data, the first data samples being classified as members of a first consistency class, the process including: selecting second data samples from second input data based on predictions from a surrogate membership classification model, wherein the second data samples are predicted by the surrogate membership classification model to be members of a second consistency class different from the first consistency class based on feature content of each data sample of the second input data; weighting each data sample of the second data samples based on a consistency score relative to the first data samples; and retraining the target machine learning model using the second data samples, based on the selecting operation and the weighting operation.

This summary is provided to introduce a selection of concepts in a simplified form. The concepts are further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTION OF THE FIGURES

FIG. 1 illustrates an example computing system for retraining a target machine learning model.

FIG. 2 illustrates an example retraining manager for retraining a trained target machine learning model.

FIG. 3 illustrates example operations for retraining a target machine learning model.

FIG. 4 illustrates an example computing device for use in implementing the described technology.

### DETAILED DESCRIPTION

Performance degradation of machine learning models can be caused by a variety of influences. One such influence is referred to as “data drift,” wherein the current input data samples no longer conform to the distribution of the initial training set. Even when there is no abrupt change in the nature of the input data, small changes can accumulate over time to degrade the model's performance. In either case, retraining the model can realign or broaden the model's accuracy with respect to the contemporaneous distribution of the input data.

Retraining a machine learning model can help maintain the performance of the model over time in the presence of data drift. Retraining may be performed as “offline retraining,” wherein the model is retrained with a batch of input samples from time to time. Such retraining may be scheduled according to a predetermined cadence or triggered when a predefined degradation condition is satisfied (e.g., accuracy decreases below a threshold). Alternatively, retraining may be performed as “online retraining,” wherein the model is retrained as the input data is received (e.g., one input data sample at a time). However, retraining is a costly endeavor in terms of computing resources, and such approaches do not evaluate which input data samples substantially contribute to improvement in the model's performance. For example, even when model degradation is detected, the input data samples used in retraining may result in little improvement in model performance because these samples may not substantially change the parameters of the model. As such, this scenario leads to wasted computing time for the computing systems executing the machine learning model and retrainer because the retraining does not improve the model performance to a substantial degree.

Generally, the term “hyperparameters,” as used herein with respect to machine learning, refers to a parameter having a value that is used to control the learning process and the model selection task of a machine learning algorithm. Hyperparameters are set by the user or machine learning model designer before applying the machine learning algorithm to a dataset. Hyperparameters are not learned from the training data or part of the resulting model. Examples of hyperparameters are the topology and size of a neural network, the learning rate, and the batch size. Hyperparameter tuning is finding the optimal values of hyperparameters for the best performance of the algorithm.

In contrast, a machine learning model is also characterized by model parameters (also referred to as “parameters”) that are learned during a training or retraining operation. These parameters include, for example, the weights and biases formed by the algorithm as it is being trained and are intended to ideally fit a data set without going over or under.

The described technology evaluates the feature content of data samples from input data sets to determine if they are members of different consistency classes as compared to data samples that were previously used to train a target machine learning model. One or more such inconsistent data samples can trigger retraining of the target machine learning model using selected data samples from the new input data set. Such a trigger can automatically identify appropriate retraining data and input the identified retraining data into the machine learning model during a retraining phase, which can execute concurrently (e.g., in parallel) with inference phases of the machine learning model or in batch mode (e.g., in sequence with different inference phases of the machine learning mode. Accordingly, the described technology can provide a technical benefit of indicating (e.g., automatically triggering the retraining operations) when a retraining operation is advisable (e.g., detection of a number of inconsistent data samples that exceeds a predefined threshold) and/or selecting data samples from the new input data set that are expected to be most effective in retraining the target data set to reduce, eliminate, and/or reverse performance degradation of the model.

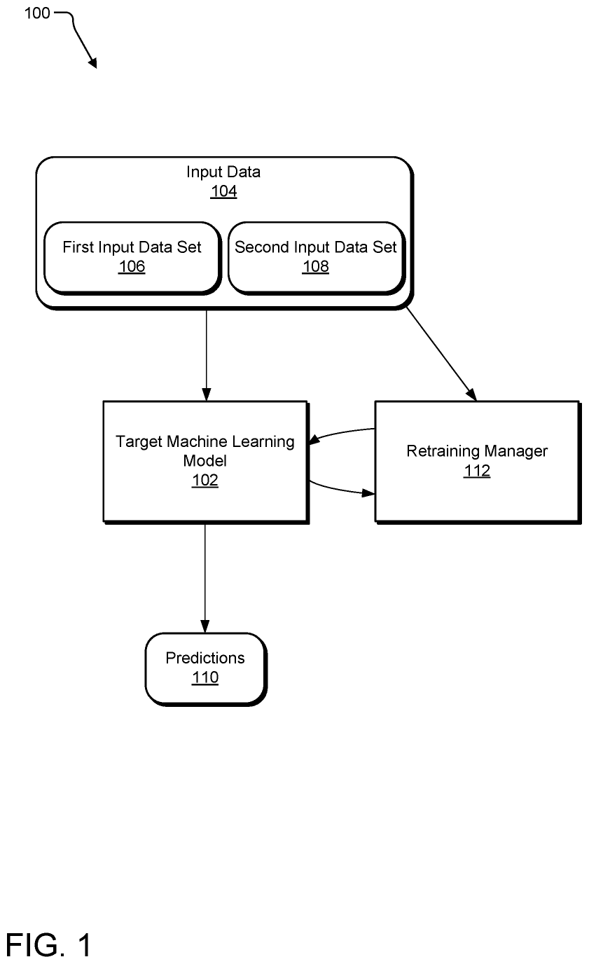

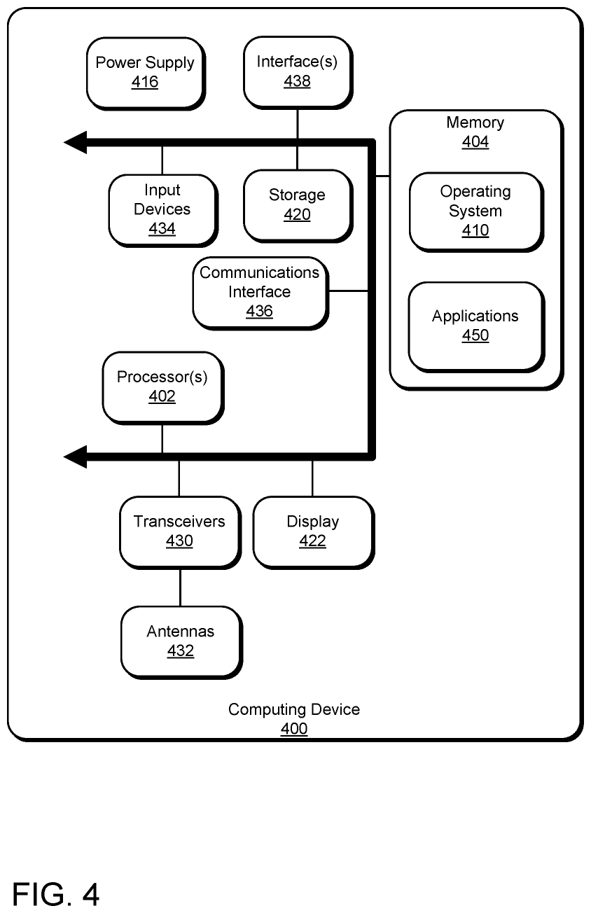

FIG. 1 illustrates an example computing system 100 for retraining a target machine learning model 102. It should be understood that elements of the described technology (e.g., a machine learning model retrainer, a retraining manager, and the trained/retrained instances of a machine learning model) may be executed in a single computing device, individually in separate computing devices, or across a distributed collections of computing devices, such as a computing device illustrated in and describe with respect to FIG. 4. In one example, the machine learning model is retrained in situ, such as in a medical imaging system or post-processing system, in parallel with the medical image processing, or within a datacenter or other computing environment. However, the model can also be uploaded to a retraining system, retrained, and then installed back into the processing system. In various implementations, the described retraining machine learning models can be applied to weather predictions, disease tracking, medical patient diagnosis and treatment, autonomous vehicles, online data searches, resource scheduling, recommendations, and other use cases.

The target machine learning model 102 receives input data samples from input data 104, which includes a first input data set 106 and a second input data set 108. The target machine learning model 102 has been previously trained using training data samples from the first input data set 106, which can typically be considered “older data” relative to a second input data set 108 (“newer data”) in that the first input data set 106 is received and input to the target machine learning model 102 before the second input data set 108.

By evaluating data samples from the second input data set 108 with respect to data samples from the first input data set 106, the computing system 100 can determine whether the feature content of data samples from the second input data set 108 has changed or drifted enough from the feature content of the data samples from the first input data set 106 to degrade performance of the target machine learning model 102 to unacceptable levels. Such evaluation can indicate when retraining is advisable to resolve such degradation and can identify which data samples from the second input data set 108 can be used to retrain the computing system 100 to provide a substantial improvement in the model performance. As such, the described technology provides technical benefits including allowing retraining to be scheduled in a more efficient manner than simply periodic retraining and tuning online (e.g., real-time) training operations without any discernment based on the consistency between data samples of the first and second data sets. For example, if the second input data set 108 is consistent with (e.g., sharing a similar statistical distribution as) the first input data set 106, retraining using training data from the second input data set 106 would likely be unnecessary, as the model had already been trained by similar data samples. Moreover, where some data samples of the second input data set 108 are consistent with those of the first data set 106 and other data samples of the second input data set 108 are not, retraining with just the inconsistent data samples would be more efficient than retraining with the consistent data samples, which would not substantially improve model performance.

In an inference flow, the target machine learning model 102 receives input data 104 and generates predictions 110. For example, the input data 104 may represent images from medical imaging, and the predictions 110 may include identification of recognized elements (e.g., lesions, tumors, implants, fractures) detected in the images. In FIG. 1, the first input data set 106 includes data samples that have been used to previously train the target machine learning model 102. In some scenarios, data drift can cause the accuracy of the target machine learning model 102 to degrade as newer data (the second input data set 108) is input to the target machine learning model 102. (In this example, accurate identification of recognized elements in medical imaging data samples represents a measure of performance. However, in the presence of data drift, such identification may grow more and more inaccurate.) Such data drift can occur, for example, when data samples of the second input data set 108 are inconsistent with the data samples of the first input data set 106 on which the target machine learning model 102 was previously trained. In this case, the data samples of the first input data set 106 are deemed to be members of a first consistency class, and the data samples of the second input data set 108 are deemed to be members of a second consistency class. In some implementations, the first consistency class and the second consistency class are mutually exclusive or substantially mutually exclusive.

In one implementation, a retraining manager 112 can evaluate the first input data set 106 and the second input data set 108 to identify when the input data 104 has drifted to the extent to exceed acceptable performance degradation. For example, in one implementation, if the retraining manager 112 detects that performance degradation satisfies a predefined degradation condition (e.g., a number of data samples of the second input data set 108 predicted to be outside the consistency class of the first input data set 106 exceeds a predefined threshold, accuracy of the target machine learning model 102 decreases below a threshold), then the retraining manager 112 selects data samples from the second input data set 108 and stored them into a data repository held in computing memory for use in retraining the target machine learning model 102 (e.g., batch retraining or online retraining). In an alternative implementation, individual data samples of the second input data set 108 are evaluated to classify them in the first consistency class or in a different consistency class (e.g., a second consistency class). If a data sample of the second input data set 108 is classified in a different consistency class than the first consistency class, the retraining manager 112 uses that data sample to retrain the target machine learning model 102, whether in a batch retraining mode with other identified data samples or in an online retraining mode (e.g., in real time, as each data sample is received and evaluated).

While the second input data set 108 is described in some implementations as a more recent data set than the first input data set 106, it is the feature content of the data samples that determines whether the data samples of the second input data set 108 are inconsistent with the data samples of the first input data set 106. The retraining manager 112 evaluates feature content features of the data samples of the first input data set 106 and second input data set 108 and classifies the data samples of the second input data set 108 in one consistency class or another using a surrogate membership classification model that is trained on data samples from both input data sets.

Accordingly, the retraining manager 112 evaluates the feature content of the input data 104, determines data sample memberships in one or more consistency classes, and retrains the target machine learning model 102 using data samples outside the consistency class on which the target machine learning model 102 was previously trained.

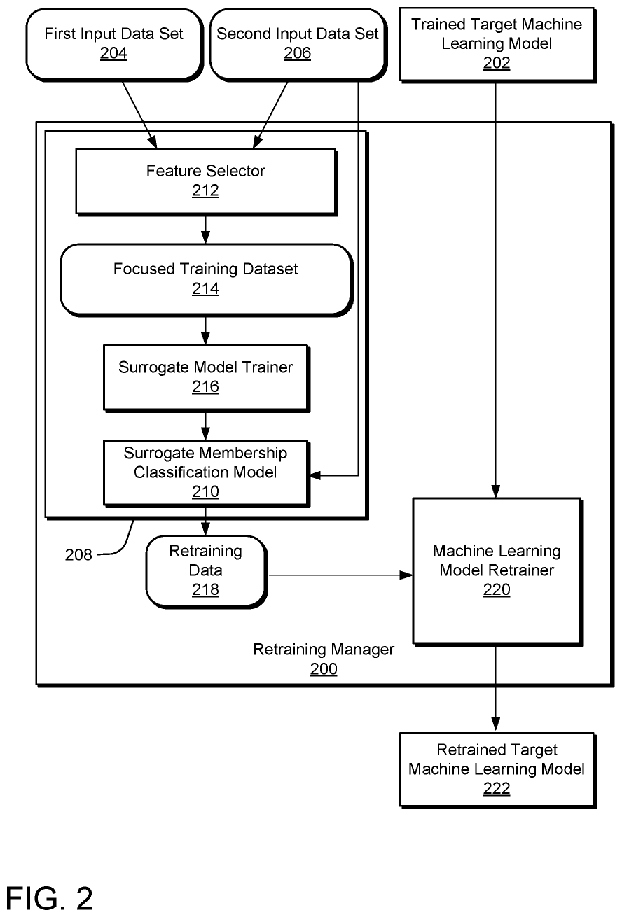

FIG. 2 illustrates an example retraining manager 200 for retraining a trained target machine learning model 202. The retraining manager 200 is configured to input a first input data set 204 and a second input data set 206. In some implementations, the first input data set 204 is input as training data to a target machine learning model (with which the retraining manager 200 is operating) before the second input data set 206 to yield the trained target machine learning model 202, although, in other implementations, the first input data set 204 simply includes data samples previously used to train the target machine learning model and the second input data set 206 does not. The retraining manager 200 includes a retraining data selector 208 configured to select second data samples from the second input data set 206 based on predictions of a surrogate membership classification model 210. Aspects of this flow are described below.

In some implementations, a feature selector 212 extracts a global feature importance matrix for the first input data set 204 and the second input data set 206 relative to the trained target machine learning model 202, such as by using SHAP (SHapley Additive exPlanations), LIME (Local Interpretable Model-agnostic Explanations), or some other kind of permutation test). SHAP, for example, assists in interpreting machine learning models with Shapely values, which are measures of the contributions each feature (predictor) has in a machine learning model. In one view, Shapely values are measures of how important a specific feature is to the predictions made by the model. Generally, the global feature importance matrix represents a table in which each feature (e.g., components of the feature vectors s_{feature}) is associated with a measurement or score that indicates its relative importance to the decisions made during prediction by the trained target machine learning model 202. Accordingly, the feature selector 212 yields a list of “focus” features (see, e.g., a subset of the original list of features in the previous training data Dₚᵣₑᵥ from the first input data set 204).

When evaluating and implementing retraining management, the retraining data selector 208 repurposes the training data of the first input data set 204 for a new “surrogate” task that is different from the main target prediction task for which the trained target machine learning model 202 is intended. For the surrogate task, the training data of the first input data set 204 is relabeled. Whereas the original training data had labels relevant to the target predictions of the main target prediction task, the feature selector 212 labels the training data samples of the first input data set 204 to “1,” designating them as members of a positive (P) dataset and indicating that the corresponding data samples are in the first consistency class. In contrast, data samples of the second input data set 206 are labeled as “U,” designating them as members of an unknown or unlabeled (U) data set and indicating that the corresponding data samples are in an as-yet unassigned consistency class.

In some implementations, the data samples from both sets are focused to include feature vectors that are deemed important enough to the trained target machine learning model 202 to contain relevant and signal-rich features, although such focusing may be omitted in some implementations, thereby potentially reducing the number of data samples employed in the retraining. The decision of “important enough” is evaluated against a focus condition, such as a threshold score for a data sample in the global feature importance matrix that exceeds a predefined threshold.

In one implementation, a hyperparameter threshold t, which can be tuned by users, is attributed to the input data so that data samples for which weights w<t are dropped, where weights w are trainable parameters of the model. As such, data samples that have a very high probability of being consistent with the training data of the first data set can be ignored, thereby reducing the number of samples from nBatch to a smaller number nUseful<nBatch.

Whether focused or not, the data samples from the first input data set 204, labeled with “1,” and the second input data set 206, labeled with “U,” are concatenated into a new training data set (see, e.g., a focused training dataset 214 with the following schema) for training the surrogate membership classification model 210 in the context of Positive Unlabeled (PU) learning, where the labeled samples and the unlabeled samples may come from different statistical distributions:

$$\\ \begin{matrix}Focused & {S}_{prev \_ 1} ; & label = 1 \\ ⋯ & & \\ Focused & {S}_{prev \_ nTraining} ; & label = 1 \\ Focused & {S}_{new \_ 1} ; & label = U \\ ⋯ & & \\ Focused & {S}_{new \_ nUnlabeled} ; & label = U\end{matrix}$$

where Sₚᵣₑᵥ represents data samples from the first input data set 204 from 1 to the number of data samples in the previous training set, and S_{new} represents data samples from the second input data set 206 from 1 to the number of data samples in the unlabeled set. In some implementations, labeling is implemented by a software-managed initialization of the data samples.

A surrogate model trainer 216 receives the new PU training dataset (e.g., the focused training dataset 214) and uses it to train the surrogate membership classification model 210. Data samples from the second input data set 206 are input to the (trained) surrogate membership classification model 210, which outputs predictions/scores of whether individual data samples of the second input data set 206 are in the first consistency class of the first input data set 204 or are in a different consistency class. The retraining data selector 208 selects those data samples predicted to be in a different consistency class as retraining data 218 for a machine learning model retrainer 220, which retrains trained target machine learning model 202 to yield a retrained machine learning model 222.

The surrogate membership classification model 210 is characterized as a binary classification model trained on the PU training dataset. Given an unlabeled data sample from the second input data set 206, the output of the surrogate membership classification model 210 includes a consistency score in the form of a probability value p. When p is very close to 1, the unlabeled data sample is very likely to have been drawn from the same statistical distribution (e.g., the same consistency class) as the first input data set 204. In contrast, when p is very close to 0, the unlabeled data sample is very likely to have been drawn from a different statistical distribution (e.g., a different consistency class) as the first input data set 204. As such, in this implementation, the data samples of the latter grouping, as delineated by an inconsistency condition (e.g., p being lower than a predefined threshold, p being sufficiently separated from the p values of the first input data set 204), are added to the retraining data 218.

In some implementations, the data samples in the retraining data 218 are individually weighted according to the amount by which they are inconsistent with the first input data set 204. For example, in one implementation, a weight w is assigned to each data sample, such that w=1−p. As such, data samples from the second input data set 206 with w close to 1 are considered very inconsistent from those in the first input data set 204, thereby carrying strong new information for retraining the trained target machine learning model 202. In contrast, data samples from the second input data set 206 with w close to 0 are considered very consistent with those in the first input data set 204, thereby carrying little new information for retraining the trained target machine learning model 202. In one example, the retraining data 218 may be recorded in a schema data structure in memory for batch retraining, such as:

$$\\ \begin{matrix}{S}_{new \_ 1} , & {S}_{feature \_ new \_ 1} , & {W}_{1} \\ ⋯ & & \\ {S}_{new \_ nBatch} , & {S}_{feature \_ new \_ nBatch} , & {W}_{nBatch}\end{matrix}$$

where S_{new} represents data samples from the second input data set 206 from 1 to the number of data samples retraining batch, and s_{feature_new} represents data samples from the second input data set 206 corresponding to focused features identified by the feature selector 212 from 1 to the number of data samples retraining batch, and w represents the weight attributed to each data sample. For online retraining, the retraining data 218 may include only a single row of data.

In some implementations, each data sample is evaluated by the retraining data selector 208 as it is received. If the data sample is selected by the retraining data selector 208 as being in a different consistency class than the first input data set 204, the data sample is used by the machine learning model retrainer 220 in real time or substantially real time to retrain the trained target machine learning model 202, sometimes referred to as online retraining. In other implementations, sometimes referred to as batch or offline retraining, the data samples selected by the retraining data selector 208 as being in a different consistency class than the first input data set 204 are accumulated until the selected data samples satisfy a retraining condition (e.g., the number of selected data samples exceed a predefined batch retraining threshold), after which, a batch retraining operations is triggered using the selected data samples.

Thus, the described technology provides a method of retraining a target machine learning model by identifying inconsistencies in the feature content of new data samples relative to the feature content of data samples previously used to train the target machine learning model. Based on the identified inconsistencies, a machine learning model retrainer 220 can trigger a batch retraining operation or can execute online retraining as the new, inconsistent data samples are received. Furthermore, the new, inconsistent data samples can be weighted according to a measure of their inconsistency with the training data samples of the first input data set 204.

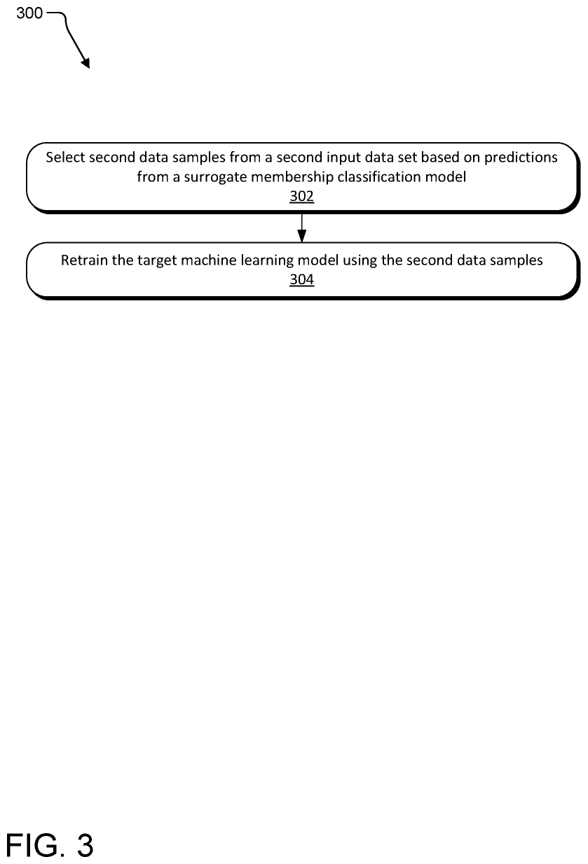

FIG. 3 illustrates example operations 300 for retraining a target machine learning model. The target machine learning model is trained based on training data samples from a first input data set. A selection operation 302 selects second data samples from a second input data set based on predictions from a surrogate membership classification model. The predictions from a surrogate membership classification model indicate a likelihood that a data sample has been drawn from a different statistical distribution (e.g., a different consistency class) than the first input data set, as indicated in some implementations by a consistency score attributed to each data sample by a surrogate membership classification model. Such “inconsistent” data samples are likely to degrade the performance of the target machine learning model on the data samples. Accordingly, detection of the inconsistent data samples suggests that retraining the target machine learning model with data samples from the different consistency class will reduce, eliminate, or reverse the degradation.

When a retraining condition is satisfied (e.g., a number of inconsistent data samples being identified that exceeds a predefined threshold), a retraining operation 304 is triggered to retrain the target machine learning model with training data from the second data samples. If the retraining condition specifies that detection of even a single inconsistent data sample can trigger retraining, the scenario is considered online retraining. If the retraining condition specifies that detection of more than one inconsistent data sample is needed to trigger retraining, the scenario is considered batch retraining.

The selection operation 302 may include various suboperations. In one implementation, a feature selection suboperation selects features of higher importance to the decisions of the target machine learning model. A training data set building suboperation combines selected feature vectors for data samples from both old and new input data sets to yield a focused training data set that is used to train a surrogate membership classification model. The surrogate classification model is executed in an inference mode to perform a classification suboperation that selects data samples from the new input data set to retrain the target machine learning model, subject to the satisfaction of a retraining condition. In some implementations, the feature selection suboperation may be deemphasized or omitted.

FIG. 4 illustrates an example computing device 400 for use in implementing the described technology. The computing device 400 may be a client computing device (such as a laptop computer, a desktop computer, or a tablet computer), a server/cloud computing device, an Internet-of-Things (IoT), any other type of computing device, or a combination of these options. The computing device 400 includes one or more processor(s) 402 and a memory 404. The memory 404 generally includes both volatile memory (e.g., RAM) and nonvolatile memory (e.g., flash memory), although one or the other type of memory may be omitted. An operating system 410 resides in the memory 404 and is executed by the processor(s) 402. In some implementations, the computing device 400 includes and/or is communicatively coupled to storage 420.

In the example computing device 400, as shown in FIG. 4, one or more modules or segments, such as applications 450, a retraining data selector, a retraining manager, a feature selector, a surrogate model trainer, a machine learning model retrainer, and other program code and modules are loaded into the operating system 410 on the memory 404 and/or the storage 420 and executed by the processor(s) 402. The storage 420 may store a first input data set, a second input data set, a focused training dataset, retraining data, and other data and be local to the computing device 400 or may be remote and communicatively connected to the computing device 400. In particular, in one implementation, components of a system retraining a target machine learning model may be implemented entirely in hardware or in a combination of hardware circuitry and software.

The computing device 400 includes a power supply 416, which may include or be connected to one or more batteries or other power sources, and which provides power to other components of the computing device 400. The power supply 416 may also be connected to an external power source that overrides or recharges the built-in batteries or other power sources.

The computing device 400 may include one or more communication transceivers 430, which may be connected to one or more antenna(s) 432 to provide network connectivity (e.g., mobile phone network, Wi-Fi®, Bluetooth®) to one or more other servers, client devices, IoT devices, and other computing and communications devices. The computing device 400 may further include a communications interface 436 (such as a network adapter or an I/O port, which are types of communication devices). The computing device 400 may use the adapter and any other types of communication devices for establishing connections over a wide-area network (WAN) or local-area network (LAN). It should be appreciated that the network connections shown are exemplary and that other communications devices and means for establishing a communications link between the computing device 400 and other devices may be used.

The computing device 400 may include one or more input devices 434 such that a user may enter commands and information (e.g., a keyboard, trackpad, or mouse). These and other input devices may be coupled to the server by one or more interfaces 438, such as a serial port interface, parallel port, or universal serial bus (USB). The computing device 400 may further include a display 422, such as a touchscreen display.

The computing device 400 may include a variety of tangible processor-readable storage media and intangible processor-readable communication signals. Tangible processor-readable storage can be embodied by any available media that can be accessed by the computing device 400 and can include both volatile and nonvolatile storage media and removable and non-removable storage media. Tangible processor-readable storage media excludes intangible communications signals (such as signals per se) and includes volatile and nonvolatile, removable and non-removable storage media implemented in any method, process, or technology for storage of information such as processor-readable instructions, data structures, program modules, or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 400. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Clause 1. A method of retraining a target machine learning model trained by first data samples from first input data, the first data samples being classified as members of a first consistency class, the method comprising: selecting second data samples from second input data based on predictions from a surrogate membership classification model, wherein the second data samples are predicted by the surrogate membership classification model to be members of a second consistency class different from the first consistency class based on feature content of each data sample of the second input data; and retraining the target machine learning model using the second data samples, based on the selecting operation.

Clause 2. The method of clause 1, wherein the selecting operation comprises: training the surrogate membership classification model using a focused training dataset selected from the first input data and the second input data.

Clause 3. The method of clause 1, wherein the selecting operation comprises: generating a feature importance matrix for the first input data and the second input data relative to the target machine learning model.

Clause 4. The method of clause 3, wherein the selecting operation comprises: training the surrogate membership classification model using a focused training dataset selected from the first input data and the second input data and the focused training dataset is selected based on the feature importance matrix.

Clause 5. The method of clause 1, wherein the first input data is input to the target machine learning model before the second input data.

Clause 6. The method of clause 1, wherein the selecting operation comprises: generating, by the surrogate membership classification model, a consistency score for each data sample of the second input data; and identifying the second data samples based on whether the consistency score of each data sample of the second input data satisfies a membership condition.

Clause 7. The method of clause 1, wherein the first consistency class and the second consistency class are mutually exclusive.

Clause 8. A computing system for retraining a target machine learning model trained by first data samples from first input data, the first data samples being classified as members of a first consistency class, the computing system comprising: one or more hardware processors; a retraining data selector executable by the one or more hardware processors and configured to select second data samples from second input data based on predictions from a surrogate membership classification model, wherein the retraining data selector includes a surrogate membership classification model configured to predict the second data samples from the second input data to be members of a second consistency class different from the first consistency class based on feature content of each data sample of the second input data; and a machine learning model retrainer executable by the one or more hardware processors and configured to retrain the target machine learning model using the second data samples.

Clause 9. The computing system of clause 8, wherein the surrogate membership classification model is trained using a focused training dataset selected from the first input data and the second input data.

Clause 10. The computing system of clause 8, further comprising: a feature selector executable by the one or more hardware processors and configured to generate a feature importance matrix for the first input data and the second input data relative to the target machine learning model.

Clause 11. The computing system of clause 10, further comprising: a surrogate model trainer executable by the one or more hardware processors and configured to train the surrogate membership classification model using a focused training dataset selected from the first input data and the second input data and the focused training dataset is selected based on the feature importance matrix.

Clause 12. The computing system of clause 8, wherein the second data samples are weighted based on a consistency score relative to the first data samples prior to retraining of the target machine learning model.

Clause 13. The computing system of clause 8, wherein the retraining data selector is further configured to generate, by the surrogate membership classification model, a consistency score for each data sample of the second input data and to identify the second data samples based on whether the consistency score of each data sample of the second input data satisfies a membership condition.

Clause 14. The computing system of clause 8, wherein retraining data selector is further configured to trigger retraining based on data samples of the second consistency class satisfying a retraining condition.

Clause 15. One or more tangible processor-readable storage media embodied with instructions for executing on one or more processors and circuits of a computing device a process of retraining a target machine learning model trained by first data samples from first input data, the first data samples being classified as members of a first consistency class, the process comprising: selecting second data samples from second input data based on predictions from a surrogate membership classification model, wherein the second data samples are predicted by the surrogate membership classification model to be members of a second consistency class different from the first consistency class based on feature content of each data sample of the second input data; weighting each data sample of the second data samples based on a consistency score relative to the first data samples; and retraining the target machine learning model using the second data samples, based on the selecting operation and the weighting operation.

Clause 16. The one or more tangible processor-readable storage media of clause 15, wherein the selecting operation comprises: training the surrogate membership classification model using a focused training dataset selected from the first input data and the second input data.

Clause 17. The one or more tangible processor-readable storage media of clause 15, wherein the selecting operation comprises: generating a feature importance matrix for the first input data and the second input data relative to the target machine learning model.

Clause 18. The one or more tangible processor-readable storage media of clause 17, wherein the selecting operation comprises: training the surrogate membership classification model using a focused training dataset selected from the first input data and the second input data and the focused training dataset is selected based on the feature importance matrix.

Clause 19. The one or more tangible processor-readable storage media of clause 15, wherein the selecting operation comprises: generating, by the surrogate membership classification model, a consistency score for each data sample of the second input data; and identifying the second data samples based on whether the consistency score of each data sample of the second input data satisfies a membership condition.

Clause 20. The one or more tangible processor-readable storage media of clause 15, wherein the first consistency class and the second consistency class are mutually exclusive.

Clause 21. A system for retraining a target machine learning model trained by first data samples from first input data, the first data samples being classified as members of a first consistency class, the system comprising: means for selecting second data samples from second input data based on predictions from a surrogate membership classification model, wherein the second data samples are predicted by the surrogate membership classification model to be members of a second consistency class different from the first consistency class based on feature content of each data sample of the second input data; and means for retraining the target machine learning model using the second data samples, based on the selecting operation.

Clause 22. The system of clause 21, wherein the means for selecting comprises: means for training the surrogate membership classification model using a focused training dataset selected from the first input data and the second input data.

Clause 23. The system of clause 21, wherein the means for selecting comprises: means for generating a feature importance matrix for the first input data and the second input data relative to the target machine learning model.

Clause 24. The system of clause 23, wherein the means for selecting comprises: means for training the surrogate membership classification model using a focused training dataset selected from the first input data and the second input data and the focused training dataset is selected based on the feature importance matrix.

Clause 25. The system of clause 21, wherein the first input data is input to the target machine learning model before the second input data.

Clause 26. The system of clause 21, wherein the means for selecting comprises: means for generating, by the surrogate membership classification model, a consistency score for each data sample of the second input data; and means for identifying the second data samples 412704-US-NP based on whether the consistency score of each data sample of the second input data satisfies a membership condition.

Clause 27. The system of clause 21, wherein the first consistency class and the second consistency class are mutually exclusive.

Some implementations may comprise an article of manufacture, which excludes software per se. An article of manufacture may comprise a tangible storage medium to store logic and/or data. Examples of a storage medium may include one or more types of computer-readable storage media capable of storing electronic data, including volatile memory or nonvolatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, operation segments, methods, procedures, software interfaces, application program interfaces (API), instruction sets, computing code, computer code, code segments, computer code segments, words, values, symbols, or any combination thereof. In one implementation, for example, an article of manufacture may store executable computer program instructions that, when executed by a computer, cause the computer to perform methods and/or operations in accordance with the described embodiments. The executable computer program instructions may include any suitable types of code, such as source code, compiled code, interpreted code, executable code, static code, dynamic code, and the like. The executable computer program instructions may be implemented according to a predefined computer language, manner, or syntax, for instructing a computer to perform a certain operation segment. The instructions may be implemented using any suitable high-level, low-level, object-oriented, visual, compiled, and/or interpreted programming language.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A method of retraining a target machine learning model trained by first data samples from first input data, the first data samples being classified as members of a first consistency class, the method comprising:
selecting second data samples from second input data based on predictions from a surrogate membership classification model, wherein the second data samples are predicted by the surrogate membership classification model to be members of a second consistency class different from the first consistency class based on feature content of each data sample of the second input data; and
retraining the target machine learning model using the second data samples, based on the selecting operation.

2. The method of claim 1, wherein the selecting operation comprises:
training the surrogate membership classification model using a focused training dataset selected from the first input data and the second input data.

3. The method of claim 1, wherein the selecting operation comprises:
generating a feature importance matrix for the first input data and the second input data relative to the target machine learning model.

4. The method of claim 3, wherein the selecting operation comprises:
training the surrogate membership classification model using a focused training dataset selected from the first input data and the second input data and the focused training dataset is selected based on the feature importance matrix.

5. The method of claim 1, wherein the first input data is input to the target machine learning model before the second input data.

6. The method of claim 1, wherein the selecting operation comprises:
generating, by the surrogate membership classification model, a consistency score for each data sample of the second input data; and
identifying the second data samples based on whether the consistency score of each data sample of the second input data satisfies a membership condition.

7. The method of claim 1, wherein the first consistency class and the second consistency class are mutually exclusive.

8. A computing system for retraining a target machine learning model trained by first data samples from first input data, the first data samples being classified as members of a first consistency class, the computing system comprising:
one or more hardware processors;
a retraining data selector executable by the one or more hardware processors and configured to select second data samples from second input data based on predictions from a surrogate membership classification model, wherein the retraining data selector includes a surrogate membership classification model configured to predict the second data samples from the second input data to be members of a second consistency class different from the first consistency class based on feature content of each data sample of the second input data; and
a machine learning model retrainer executable by the one or more hardware processors and configured to retrain the target machine learning model using the second data samples.

9. The computing system of claim 8, wherein the surrogate membership classification model is trained using a focused training dataset selected from the first input data and the second input data.

10. The computing system of claim 8, further comprising:
a feature selector executable by the one or more hardware processors and configured to generate a feature importance matrix for the first input data and the second input data relative to the target machine learning model.

11. The computing system of claim 10, further comprising:
a surrogate model trainer executable by the one or more hardware processors and configured to train the surrogate membership classification model using a focused training dataset selected from the first input data and the second input data and the focused training dataset is selected based on the feature importance matrix.

12. The computing system of claim 8, wherein the second data samples are weighted based on a consistency score relative to the first data samples prior to retraining of the target machine learning model.

13. The computing system of claim 8, wherein the retraining data selector is further configured to generate, by the surrogate membership classification model, a consistency score for each data sample of the second input data and to identify the second data samples based on whether the consistency score of each data sample of the second input data satisfies a membership condition.

14. The computing system of claim 8, wherein the retraining data selector is further configured to trigger retraining based on data samples of the second consistency class satisfying a retraining condition.

15. One or more tangible processor-readable storage media embodied with instructions for executing on one or more processors and circuits of a computing device a process of retraining a target machine learning model trained by first data samples from first input data, the first data samples being classified as members of a first consistency class, the process comprising:
selecting second data samples from second input data based on predictions from a surrogate membership classification model, wherein the second data samples are predicted by the surrogate membership classification model to be members of a second consistency class different from the first consistency class based on feature content of each data sample of the second input data;
weighting each data sample of the second data samples based on a consistency score relative to the first data samples; and
retraining the target machine learning model using the second data samples, based on the selecting operation and the weighting operation.

16. The one or more tangible processor-readable storage media of claim 15, wherein the selecting operation comprises:
training the surrogate membership classification model using a focused training dataset selected from the first input data and the second input data.

17. The one or more tangible processor-readable storage media of claim 15, wherein the selecting operation comprises:
generating a feature importance matrix for the first input data and the second input data relative to the target machine learning model.

18. The one or more tangible processor-readable storage media of claim 17, wherein the selecting operation comprises:
training the surrogate membership classification model using a focused training dataset selected from the first input data and the second input data and the focused training dataset is selected based on the feature importance matrix.

19. The one or more tangible processor-readable storage media of claim 15, wherein the selecting operation comprises:
generating, by the surrogate membership classification model, a consistency score for each data sample of the second input data; and
identifying the second data samples based on whether the consistency score of each data sample of the second input data satisfies a membership condition.

20. The one or more tangible processor-readable storage media of claim 15, wherein the first consistency class and the second consistency class are mutually exclusive.
